(19) United States
(12) Patent Application Publication
(10) Pub. No.: US 2020/0005351 A1
(43) Pub. Date: Jan. 2, 2020

(54) Systems and Methods for Providing Offers Based on User Location Profiles

(71) Applicant: MASTERCARD INTERNATIONAL INCORPORATED, PURCHASE, NY (US)

(72) Inventors: Srishti Gupta, Kota (IN); Surbhi Chetwani, Delhi (IN); Wardah Salman Akhtar, New Delhi (IN)

(21) Appl. No.: 16/022,249

(22) Filed: Jun. 28, 2018

(51) Int. Cl. G06Q 30/02; H04W 4/029

(52) U.S. Cl. CPC G06Q 30/0224; H04W 4/029; G06Q 30/0205

(57) ABSTRACT

Systems and methods are provided for directing offers to users. One exemplary method includes receiving location records for first and second users from communication devices associated with the respective first and second users, where the location records for the first and second users each include location data and a time stamp of the location data. The method also includes determining, by an offer engine, an overlap between the first user and the second user in at least one region based on at least the time stamp included in the location records, and recognizing, by the offer engine, a link between the first user and the second user. The method further includes identifying an offer based on transaction data of the first user and providing the identified offer to the second user based on the recognized link between the first user and the second user.

### FIELD

The present disclosure generally relates to systems and methods for providing offers to users based on location profiles associated with the users, and, in particular, to systems and methods for compiling aggregate location profiles from transaction data for multiple users, where the multiple users are associated with one another, and providing offers to particular ones of the multiple users based on the aggregate location profiles.

### BACKGROUND

This section provides background information related to the present disclosure which is not necessarily prior art.

Consumers use payment accounts to purchase various different goods and services (broadly, products) from merchants. It is known for merchants, and manufacturers, to provide coupons to consumers in order to incentivize the consumers to purchase certain products. The coupons may be delivered generically to the consumers at addresses associated with the consumers (e.g., residential addresses, etc.), for example, through periodicals, such as newspapers, etc., and/or through mail delivery (e.g., “To John Smith or Current Resident”). Beyond providing these generic offers, some merchants target consumers based on prior purchasing activities of the consumers, or based on prior web searching of the consumers. Specifically, coupons are known to be delivered to consumers at checkout at stores, where the particular coupons are based on the consumers' particular purchases. Similarly, searches at merchant websites, or via particular search engines, may prompt merchants to offer coupons to the consumers for searched products when purchases are not initiated with the merchants and/or in connection with further searching. In both of these examples, merchants are permitted to offer coupons, for example, to the consumers based on the consumers' prior behaviors.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in directing offers to particular consumers, where the offers are based on transaction data associated with one or more other consumers linked to the particular consumers;

FIG. 2 is a block diagram of a computing device that may be used in the exemplary system of FIG. 1;

FIG. 3 is an exemplary method that may be implemented in connection with the system of FIG. 1 for directing an offer to a particular consumer when transaction data for a different consumer, who is linked to the particular consumer, is associated with and/or targeted for the offer; and

FIGS. 4-5 are exemplary mapping diagrams of time spent by different consumers within different regions, and which may be aggregated in the exemplary system of FIG. 1 and/or the exemplary method of FIG. 3.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Offers for products (e.g., goods and/or services, etc.) may be extended to particular consumers based on a variety of data. In general, when the data is limited to particular consumers, or to consumers that are “like” the particular consumers, the particular consumers receive the offers for products in which they may be interested in purchasing (based on the variety of data). By identifying offers in this manner, purchase opportunities associated with other consumers linked to the particular consumers are potentially lost (as the other merchants do not also receive the offers). For example, when consumers A and B are a married couple, the consumer A may have specific purchase propensities, while the consumer B may have different purchase propensities. Based on the above, offers directed to consumer B would be based on consumer B's transaction history; consumer B would not get offers specific to consumer A (and/or specific to consumer A's transaction history).

Uniquely, the systems and methods herein account for transaction histories of linked consumers (e.g., married couples, family members, friends, etc.), whereby the consumers are provided with offers based on the transaction history of other linked consumers, and taking into account, for example, relative locations of the consumers' communication devices. In particular herein, an offer engine receives and stores location records from communication devices for multiple consumers (e.g., consumers registered with the offer engine, etc.), and then aggregates time spent, per communication device, in one or more regions. The offer engine then maps the different (aggregate) times spent, in the same regions, and links the communication devices (and the consumers associated therewith) based on the map. The offer engine further relies on transaction data (e.g., as an indicator of purchase behavior, etc.) to identify the linked consumers to one or more groups. Thereafter, the offer engine identifies offers for the consumers, which are linked together based on the groups, and provides the offers to the consumers. In this manner, a first consumer may receive an offer for/based on a second consumer with whom he/she is linked, thereby permitting the first consumer to take advantage of the offer on behalf of the second consumer, or at least to subsequently provide the offer to the second consumer (or, potentially, even use the offer himself/herself). As such, consumers who do not typically receive offers for one or more reasons (or are not able to receive offers), for example, may still be reached through linked consumers who do receive (or are capable of receiving) offers. In this manner, the systems and methods herein provide a manner of reaching/targeting consumers for offers not previously available or reachable for such offers (e.g., the systems and methods herein may enable an entirely new/additional group of consumers to receive offers, etc.).

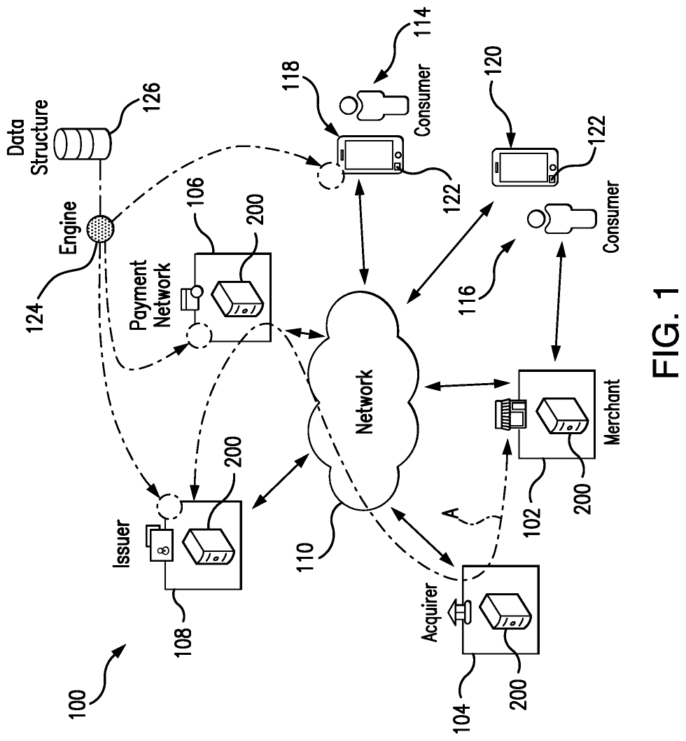

FIG. 1 illustrates an exemplary system 100, in which one or more aspects of the present disclosure may be implemented. Although the system 100 is presented in one arrangement, other embodiments may include systems arranged otherwise depending, for example, on types of offers, on offer originators, availability of transaction data for consumers and linked consumers, links between different consumers, privacy requirements, etc.

As shown in FIG. 1, the illustrated system 100 generally includes a merchant 102, an acquirer 104 associated with providing and/or managing certain accounts for the merchant 102, a payment network 106, and an issuer 108 configured to issue payment accounts to consumers, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 110 may include multiple different networks, such as a private payment transaction network made accessible by the payment network 106 to the acquirer 104 and the issuer 108 and, separately, the public Internet, which is accessible as desired to the merchant 102, the acquirer 104, the payment network 106, and/or the issuer 108, etc.

In the illustrated system 100, the merchant 102 generally offers products (e.g., goods, services, etc.) for sale to consumers, through one or more physical and/or virtual locations, etc. In connection therewith, the products may be offered for sale by the merchant 102 through physical brick-and-mortar locations or through one or more virtual locations (e.g., websites, etc.). While only one merchant is illustrated in FIG. 1, for ease of reference, it should be appreciated that multiple merchants may be employed within the system 100 in other embodiments for selling products to consumers.

The illustrated system 100 also includes two consumers: consumer 114 and consumer 116. In this exemplary embodiment, the consumers 114 and 116 live together, whereby the consumers 114 and 116 are in close proximity for a certain amount of time, per day or week, etc. As shown in FIG. 1, the consumers 114 and 116 are associated with communication devices 118 and 120, respectively. And, each of the communication devices 118 and 120 includes a mobile application 122, which configures the respective one of the communication devices 118 and 120, through computer-executable instructions, to operate as described herein. Each of the communication devices 118 and 120 may include, for example, a portable communication device such as a smartphone, a tablet, a laptop, etc. However, this is not required in all embodiments.

The consumer 114 is associated with a payment account issued by the issuer 108, and the consumer 116 is associated with a different payment account issued by the issuer 108. The payment accounts may include, for example, credit accounts, debit accounts, or prepaid accounts, etc., whereby the accounts are generally associated with and attributable to the consumers 114 and 116. The consumers 114 and 116 may use the payment accounts to fund transactions to purchase products from the merchant 102, or from other merchants as desired.

In connection therewith, the consumer 114, for example, may interact with the merchant 102 to purchase a product. In the exemplary transaction, the consumer 114 initially presents a payment device, associated with his/her payment account (e.g., as issued to the consumer 114 by the issuer 108, etc.), to the merchant 102. The payment device may include, without limitation, a credit card, a debit card, a prepaid card, a fob, or if applicable, the communication device 118, when the communication device 118 includes a payment application.

In turn in this transaction, the merchant 102 captures payment account information for the payment account of the consumer 114 from the payment device (e.g., via a virtual location of the merchant 102, via a point-of-sale terminal, etc.). Then, the merchant 102 compiles and communicates (in a generally conventional manner) an authorization request for the purchase transaction to the acquirer 104, along path A in FIG. 1, identifying, for example, a payment account number for the payment device/payment account and an amount of the purchase. Upon receipt, the acquirer 104 communicates the authorization request to the issuer 108 (that issued the payment account to the consumer 114), through the payment network 106 (e.g., through MasterCard®, VISA®, Discover®, American Express®, etc.) (again along path A), whereby the issuer 108 is configured to determine (in conjunction with the payment network 106) whether the payment account is in good standing and whether there is sufficient credit or funds to complete the purchase. If the issuer 108 accepts the transaction, a reply authorizing the transaction is provided back to the acquirer 104 and the merchant 102 (through the payment network 106), thereby permitting the merchant 102 to complete the transaction. The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108). If the issuer 108 declines the transaction, however, a reply declining the transaction is provided back to the merchant 102, thereby permitting the merchant 102 to stop the transaction.

While the above purchase transaction is described with reference to the consumer 114 and merchant 102, it should be appreciated that transactions between the consumer 114 and other merchants, as well as transactions between the consumer 116 and the merchant 102 or other merchants, would be substantially similar.

Regardless of the one of the consumers 114 and 116 and/or the merchant involved in a given transaction, transaction data is generated, collected, and stored as part of the various interactions among the consumer 114 (or consumer 116), the merchant 102 (or other merchants), the acquirer 104, the payment network 106, and the issuer 108. The transaction data, then, represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104 and/or the issuer 108 may store the transaction data, or part thereof, in a data structure, or transaction data may be transmitted between parts of system 100, as used or needed. The transaction data may include, for example, payment account numbers (e.g., primary account numbers (PANs), etc.), amounts of the transactions, merchant IDs, merchant category codes (MCCs), dates/times of the transactions, products purchased and related descriptions or identifiers, expiration dates, etc. It should be appreciated that more or less information related to transactions, as part of either authorization and/or clearing and/or settling, may be included in transaction data and stored within the system 100, at the merchant 102, the acquirer 104, the payment network 106, and/or the issuer 108.

In various exemplary embodiments, the consumers involved in the different transactions herein (including the consumers 114 and 116) are prompted to agree to legal terms associated with their payment accounts, for example, during enrollment in their accounts with issuers thereof, upon installation of payment applications, etc. In so doing, the consumers may voluntarily agree, for example, to allow merchants, issuers, payment networks, etc., to use data collected during enrollment and/or collected in connection with processing the transactions, subsequently for one or more of the different purposes described herein. Enrollment can be carried out in a variety of ways, for example, through a web interface, through an application store, and/or through a credit account issuer or other financial institution. With that said, there may be some transaction data that will not be shared even if the consumers do consent, for example, when it would be against policy or otherwise inappropriate. Further, the consumers may be afforded many options through their accounts, but some may still be restricted for legal or policy reasons or the like (e.g., appropriate age limits are preferably enforced on those enrolling, regardless of options; etc.). Moreover, appropriate usage limits are preferably placed on use of the publication, dissemination, and/or sharing of the transaction data. Of course, all applicable laws, rules, regulations, policies and procedures with respect to age of consumers, privacy, and the like will always be fully followed.

In addition, the mobile application 122 included in the communication devices 118 and 120 are associated with the proper permissions from the consumers 114 and 116 to operate as described herein. In particular, the consumers 114 and 116 may voluntarily agree to provide consent for the mobile application 122 to collect and transmit location data associated with the respective communication devices 118 and 120 as described herein Like the transaction data, appropriate limits are preferably placed on use of the publication, dissemination, and/or sharing of such location data, and further, all applicable laws, rules, regulations, policies and procedures with respect to age of consumers, privacy, and the like are to be fully followed.

While one merchant 102, one acquirer 104, one payment network 106, one issuer 108, and two consumers 114 and 116 are illustrated in FIG. 1, it should be appreciated that any number of these entities (and their associated components) may be included in the system 100, or may be included as a part of systems in other embodiments, consistent with the present disclosure.

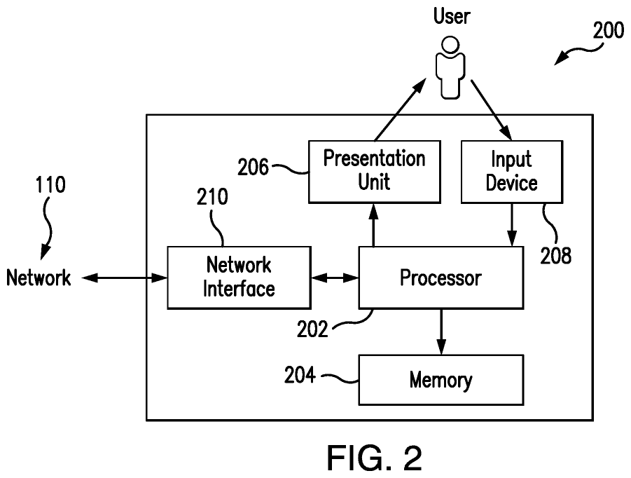

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the merchant 102, the acquirer 104, the payment network 106, and the issuer 108 are illustrated as including, or being implemented in, a computing device 200 coupled to (and in communication with) the network 110. In addition, the communication devices 118 and 120 associated with the consumers 114 and 116, respectively, may also each be considered a computing device consistent with computing device 200 for purposes of the description herein. The system 100, however, should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, location data, mappings of consumer times spent at different locations, aggregate location data, offers, consumer profiles, aggregate profiles, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is identifying and/or presenting purchase options to the consumer 114, for example. It should be appreciated that the memory 204 may include a variety of different memories, each implemented in one or more of the functions or processes described herein.

In addition, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., offers, etc.), either visually or audibly to a user of the computing device 200, for example, the consumer 114 or the consumer 116 in the system 100, etc. It should be appreciated that various interfaces (e.g., application interfaces, webpages, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, another computing device, etc. In some embodiments, presentation unit 206 may include multiple devices.

The computing device 200 also includes an input device 208 that receives inputs from the user (i.e., user inputs) such as, for example, selections of offers, requests for offers, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

Further, the illustrated computing device 200 includes a network interface 210 coupled to (and in communication with) the processor 202 and the memory 204. The network interface 210 may include, without limitation, a wired network adapter, a wireless network adapter, a mobile network adapter (e.g., an NFC adapter, a Bluetooth adapter, etc.), or other device capable of communicating to one or more different networks, including the network 110. Further, in some exemplary embodiments, the computing device 200 may include the processor 202 and one or more network interfaces incorporated into or with the processor 202. Moreover, in various embodiments herein, the input device 208 and/or the network interface 210 of the computing device 200 may include, among other things, a GPS antenna suitable to capture GPS signals for processing by the processor 202 to determine a location of the computing device 200, etc.

Referring again to FIG. 1, the system 100 further includes an offer engine 124, and a data structure 126 coupled thereto. The offer engine 124 is illustrated as a standalone part of the system 100 and, as such, may be consistent with the computing device 200. Additionally (or alternatively), as indicated by the dotted lines, the offer engine 124 may be incorporated, in whole or in part, into the payment network 106 and/or the issuer 108 and/or the communication device 118 associated with the consumer 114, and/or otherwise in the system 100. What's more, the data structure 126 is also illustrated as a separate part of the system 100, and separate from the offer engine 124. However, the data structure 126 may also be incorporated in whole, or in part, in the offer engine 124, as indicated by the dotted line therebetween, or in other parts of the system 100 (e.g., in another computing device 200 in the system 100, etc.). In various embodiments, if the offer engine 124 is incorporated into the payment network 106 or the issuer 108 or the communication device 118, the data structure 126 is likewise incorporated therein, again, in whole or in part.

Generally in the system 100, the offer engine 124 is configured, by computer-executable instructions, to (among other things) receive location records for the consumer 114 from the communication device 118 associated with the consumer 114; receive location records for the consumer 116 from the communication device 120 associated with the consumer 116 where the location records for the consumers 114 and 116 each include at least location data and a time stamp of the location data; for each of the consumers 114 and 116; determine an overlap in location between the consumers 114 and 116; recognize a link between the consumers 114 and 116, when the overlap satisfies a predetermined threshold; identify an offer based on transaction data of the consumer 116; and provide the identified offer to the consumer 114 based on the recognized link between the two consumers 114 and 116.

In particular in the illustrated system 100, the communication device 118 is configured, by the mobile application 122, to initially capture a location of the communication device 118 (e.g., via the GPS network interface 210, etc.) from time to time, or at one or more regular or irregular intervals. Upon capturing the location, the communication device 118 is configured, by the mobile application 122, to generate a location record, which includes location data (e.g., a longitude/latitude, etc.) and a time stamp at which the location data was captured. The communication device 118 is further configured, by the mobile application 122, to report the location record(s) to the offer engine 124 (e.g., via the network 110, etc.). When transmitted, the location record further includes a unique identifier for the consumer 114 and/or the communication device 118, or other identifier sufficient to identify the location record to the communication device 118 or the consumer 114 (to the exclusion of other communication devices and/or users/consumers), etc. It should be understood that the communication device 120 is configured, by the mobile application 122, in the same manner to capture location data and report corresponding location records to the offer engine 124. The offer engine 124, in turn, is configured to receive the location records from the communication devices 118 and 120 (or other communications devices) and to store the location records in the data structure 126.

The offer engine 124 is also configured to retrieve and/or receive transaction data for the consumer 114 and the consumer 116 and to store the transaction data in the data structure 126. In connection therewith, the offer engine 124 may retrieve and/or receive the transaction data from the payment network 106 or from another part of the system 100. The transaction data, as described above, is identified to the consumer 114 or the consumer 116 (or other consumers) and is thus stored in association with the corresponding consumer in the data structure 126. In this exemplary embodiment, the transaction data is, in general, received and/or retrieved apart from the location data (described above), whereby the data structure 126, in this example, includes two separate structures therein for the different types of data (although this is not required in all embodiments).

Next, the offer engine 124 is configured to identify linked consumers, based on their locations, from the location records in the data structure 126. For example, for each of the consumers 114 and 116 illustrated in FIG. 1, the offer engine 124 may be configured to determine an aggregate of time spent by the consumers 114 and 116 in one or more regions (e.g., within a residence, etc.) on a daily, weekly, or other interval basis, etc., and to identify other consumers who have been present within the one or more regions for the same or similar periods of time. Or, the offer engine 124 may be configured to generate one or more scores for consumers based on the consumers being located at common locations with the consumer 114 (or the consumer 116). The consumers are thus linked when the offer engine 124 determines that they spend a certain amount of the same time at the same region. With that said, the identification of the linked consumers may be based on proximity, time of day (e.g., night time, etc.), radius of proximity, number of hours, minutes, days, or other intervals, etc., and/or tandem movement (e.g., moving together, etc.), etc.

Also, the offer engine 124 is configured to aggregate device identifiers (or device IDs) for the consumers 114 and 116 and/or for their communication devices 118 and 120, for example, based on an identifier associated with the mobile application 122 (e.g., a wallet ID, etc.). In so doing, multiple different devices (in addition to the communication devices 118 and 120) associated with and/or used by the consumers 114 and 116, respectively, may also be accounted for and linked to each of the consumers 114 and 116 (e.g., to provide a full picture of all potential devices associated with the respective consumers 114 and 116, etc.). This, in turn, helps ensure that a complete/full spend profile for each of the consumers 114 and 116 is taken into account and/or addressed in the system 100 (e.g., prior to subsequently clustering the consumers 114 and 116 into groups/categories, as described below, whereby accuracy of such subsequent clustering may be improved; etc.).

Then in the system 100, the offer engine 124 is configured to retrieve the transaction data for each of the consumers 114 and 116, when linked together with other consumers, and to identify each of the consumers 114 and 116, based on the transaction data, to one or more groups of consumers. The groups may include, for example, predefined groups, which are clusters of consumers based on transaction data. The clusters may be specific to certain transaction behavior, such as, for example, propensity to shop at certain merchants, to shop at certain times, to spend certain amounts of money, etc. In this example, the consumer 114 is identified to a first group, while the consumer 116 is identified to a second different group. It should be appreciated that, in connection with the above, the consumers 114 and 116 may be identified to more than one group in several embodiments, whereby, as described below, multiple different offers may be directed to the consumers (based on the different groups).

Finally, the offer engine 124 is configured to bundle the identified groups for the linked consumers 114 and 116. The offer engine 124 is configured to then identify offers associated with the bundled groups and to provide the offers for the identified groups to one or each of the consumers 114 and 116. In this manner, the consumer 114 may be provided offers which are identified based on a group to which the consumer 116 is identified, and vice-versa, and may subsequently provide the offer to the consumer 116 for use, or the consumer 114 may use the offer himself/herself.

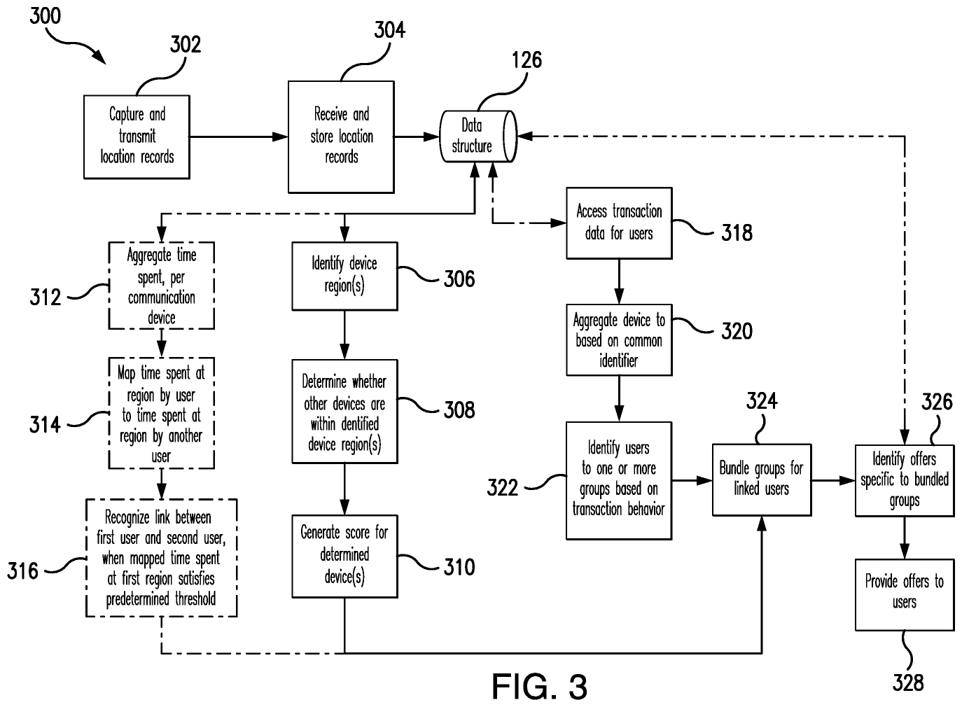

FIG. 3 illustrates an exemplary method 300 for directing an offer to a first consumer (broadly, a user in the method 300) when transaction data for a different second consumer, who is linked to the first consumer, is associated with the offer. The exemplary method 300 is described as implemented in the offer engine 124 of the system 100 (in association with the mobile application 122 at the communication device 118 of the consumer 114), with additional reference to the computing device 200. However, it should be understood that the method 300 is not limited to the system 100 or the computing device 200, as it may be implemented in other systems and/or in other computing devices Likewise, the systems and the computing devices herein should not be understood to be limited to the exemplary method 300.

Initially in the method 300, each of the communication devices 118 and 120 (and any other devices associated with and/or registered to the offer engine 124) captures a current location and then compiles and transmits a location record (indicative of the current location) to the offer engine 124, at 302. The location records generally include, without limitation, location data for the communication devices 118 and 120 (e.g., latitude/longitude data, GPS signals, reference signals, addresses, proximities, other location indications/references, etc.), time stamps (e.g., a time (e.g., HH:MM:SS, etc.), dates (e.g., MM:DD:YYYY), etc.), an identifier associated with the particular one of the communication devices 118 and 120 and/or the mobile application 122, and other suitable data that may be used as described herein. The data may include, more generally, any data about or associated with the location of the communication devices 118 and 120 that may be used to derive locations, historical trends and/or projections for locations of any of the consumers 114 and 116.

In response, the offer engine 124 receives the location records from the communication devices 118 and 120 and stores the location records in the data structure 126, at 304.

In one implementation of the method 300, the offer engine 124 identifies, at 306, one or more regions within which the communication devices 118 and 120 (and associated consumers 114 and 116) are/were present based on the received location records (e.g., for each of the received location records, for select ones of the received location records, etc.). In the illustrated method 300, this may include, for example, for each of the received location records, initially determining a specific location point indicated in the record, and then adding a given or predefined radius thereto (e.g., 10 feet, 20 feet, 30 feet, 100 feet, 1,000 feet, etc.). And then, based on the resulting location point plus radius, the offer engine 124 may identify a corresponding region for the given communication device. In connection therewith, the offer engine 124 may initially identify a region of the communication device 118 (for each location record received from the communication device 118) as a circle whereby the region of the communication device 118 may be represented (as the circle) as its GPS coordinate plus a fixed radius (e.g., plus 30 feet, etc.). Such region of the communication device 118 may then change from location to location as the communication device 118 moves (e.g., the region of the communication device 118 remains as its GPS coordinate plus fixed radius regardless of location of the communication device 118, etc.).

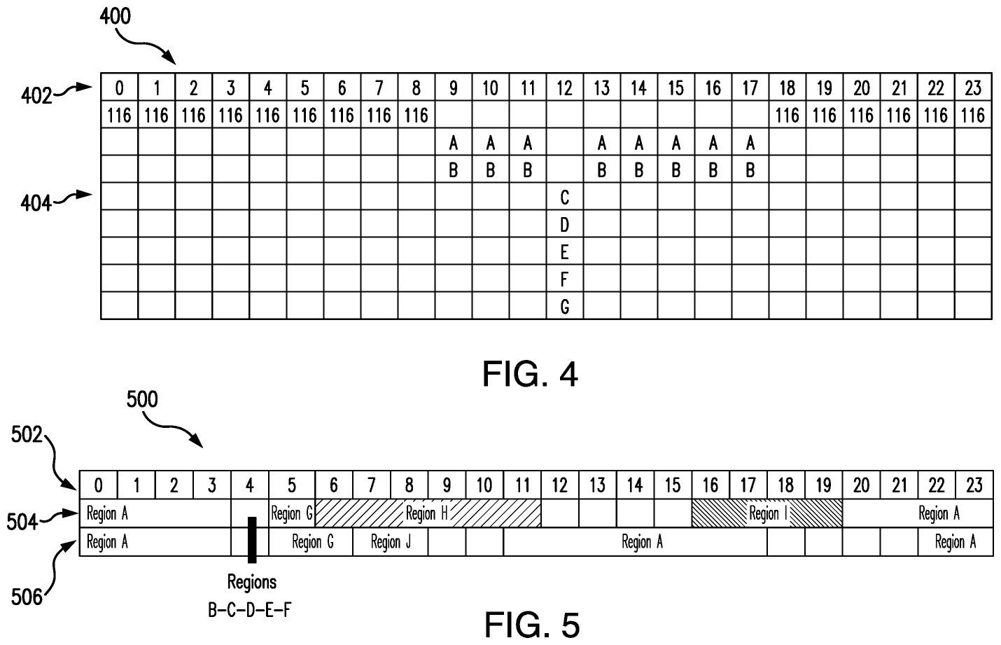

In turn, for the identified region of the communication device 118 (and/or of the communication device 120) (e.g., the particular circle plus radius of the communication device, etc.), the offer engine 124 determines, at 308, whether any other devices are included within the identified region of the communication device 118. FIG. 4 illustrates an exemplary diagram 400, or map, of a timeline of one day for the consumer 114, where each hour of the day (as a given time frame) is denoted at 402 (e.g., ranging from 0 to 23 hours). The communication devices that are located in the identified region of the communication device 118 for the consumer 114, for each of the hours of the day, are then identified at 404. As shown, the consumer 116 (based on his/her communication device 120) was located in the same region as the consumer 114 from hours 0-8 (e.g., from midnight to 9:00 AM, etc.) and also from hours 18-23 (e.g., from 7:00 PM to midnight, etc.). Consumers A and B where located in the same region as the consumer 114 from hours 9-11 (e.g., from 9:00 AM to noon, etc.) and also from hours 13-17 (e.g., from 1:00 PM to 6:00 PM, etc.). And, Consumers C, D, E, F, and G where located in the same region as the consumer 114 at hour 12 (e.g., at noon, etc.). In general, this diagram 400 may indicate that the consumer 116 lives with the consumer 114, that the consumers A, and B work with the consumer 114, and that the consumers C, D, E, F, and G at lunch at the same location as the consumer 114.

In connection with the above, and in addition to the existence of the communication devices within the identified region for the communication device 118, the communication device 118 may travel from location to location throughout the time interval (e.g., from home to work, from work to lunch and back to work, from work to home, etc.). In connection therewith, the region defined by the communication device 118 may move from location to location. The time records for the communication device 118 may then also reflect the different locations to which the communication device travels, and thus the different locations of the region of the communication device 118.

Then, at 310, the offer engine 124 generates a score for each of the determined devices (or consumers) whose region is in common with the identified region of the communication device 118.

As an example, the offer engine 124 may initially flag or tag the determined devices as “1” for the given instant (or given time frame) and for the given region (e.g., if the devices are in continuous proximity in the identified region of the communication device 118 for at least about 30 seconds, at least about one minute, at least about two minutes, etc.). Next in this example, the offer engine 124 may aggregate the generated flags for each of the determined devices that were flagged as “1” (resulting in an aggregate score for each of the determined devices), whereby ones of the devices with higher aggregate scores (e.g., scores that satisfy a predefined threshold, etc.) are more likely to be a potential family member or friend of the consumer 114 (associated with the communication device 118). In addition to the existence of the other communication device in the identified region (i.e., an overlap), the offer engine 124 may take into account the particular common locations in determination of the score. Specifically, for example, when the communication device 118 moves from location to location, and one or more communication devices are retained within the identified region of the communication device 118 (i.e., the location of the communication device 118 plus the radius), the score may be weighted in favor of a potential family member or friend based on assumptions that friends and family travel together. In the example diagram 400 of FIG. 4, the communication device 120 may be assigned an aggregate score of 15 (as it would be flagged or tagged as “1” in each of the hours 0-8 and 18-23).

In addition in this example, the offer engine 124 further assigns a likelihood score to each of the determined devices based on historical data for the devices, for example, when the determined devices are historically in the same regions as identified for the communication device 118 (but not necessarily at the same time as the communication device 118), and flags the devices as “1” when such historical data overlaps with the identified region of the communication device 118, thereby further suggesting that the ones of the determined devices with higher likelihood scores are related to the consumer 114. In the example diagram 400 of FIG. 4, the communication device 120 may also be assigned a likelihood score of 15 based on corresponding location data for the prior day (or for each day of the prior week, etc.) overlapping with location data for the consumer 114. And finally in this example, the offer engine 124 generates a net probability score for each of the determined devices as a function of the aggregate score and the likelihood score (e.g., a sum of the aggregate score and the likelihood score, a weighted sum of the aggregate score and the likelihood score, etc.). In the example diagram 400 of FIG. 4, the consumer 116 and/or the communication device 120 (associated with the consumer 116) may be assigned a net score of 30 (based on a sum of the aggregate score and the likelihood score for the consumer 116).

Alternatively in the method 300, as another implementation and as generally indicated by the dotted lines in FIG. 3, the offer engine 124 may utilize a predefined grid structure for the consumer 114, for example, comprising multiple regions (each mutually exclusive of the other) defined by the location data captured by the communication device 118 (at 302) and received by the offer engine 124 (at 304). Here, the offer engine 124 may then track presence of the communication device 120 (and any other desired devices) in the different regions of the grid structure (again, based on the location data captured from the communication devices and received by the offer engine 124 for those devices). In connection therewith, the offer engine 124 may then aggregate time spent, for each of the communication devices 118 and 120, based on the location records (and for other communication devices for which location data is received), within one or more of the identified regions of the grid structure, at 312. The aggregate time spent may include a designation of the particular region (e.g., a location and radius therefrom as described above, a name of the region, etc.), and a duration that the particular one of the communication devices 118 and 120 spent within the region. Again, the region may be specific, for example, to a residence or workplace of the consumer 114 (e.g., as an address, etc.), etc.

FIG. 5 illustrates an exemplary diagram 500, or map, of a timeline of one day for the consumers 114 and 116, where each hour of the day is denoted (e.g., from 0 to 23). The upper sequence 502 is associated with the consumer 114, and the lower sequence 504 is associated with the consumer 116. As shown, in this example, the consumer 114 was located within Region A at hours 0-3 and also at hours 20-23, thereby the offer engine 124 aggregates two times spent in Region A for the consumer 114 Likewise, the offer engine 124 aggregates three times spent in Region A for consumer 116 (i.e., from hours 0-3, 11-17 and 22-24). Other times spent are provided for Regions G, H, I and J. In addition, as further shown in FIG. 5, the consumers 114 and 116 progress through Regions B, C, D, E and F, in order within the hour 4. In general, this may indicate that each of the consumers 114 and 116 were in transit from Region A to region G (e.g., riding together in a car, etc.).

Referring again to FIG. 3, in this alternative implementation, once the times spent, per region, are aggregated, the offer engine 124 maps, at 314, the time spent at one region (e.g., Region A, etc.) by the consumer 114 to time spent in the same region by another consumer (consumer 116) over a defined interval, such as, for example, a day, a week, or other suitable interval, etc. In general, the mapping provides the overlap between the times spent by the consumer 114 in regions relative to the time spent by the other consumer 116 (or even other consumers) in the same or different regions. As shown in the diagram 500 of FIG. 5, the time spent by consumer 114 in Region A maps to the time spent by consumer 116 in Region A, to provide overlap at hours 0-3 and hours 22-23. Or, based on the mapping (via the diagram 500, for example), and stated another way, consumer 114 is present in Region A for 8 hours of the illustrated day, while the consumer 116 is present in Region A for 13 hours.

Thereafter in the method 300 (and regardless of the above implementations), the offer engine 124 recognizes, at 316, links between consumers 114 and 116 when, for example, the net probability score for the consumer 116 (generated at 310) or other score for the consumer 116 satisfies a predetermined threshold, or when the mapped time spent (generated at 314) satisfies a predetermined threshold.

For example, based on the diagram 400 of FIG. 4, the consumer 114 was assigned a probability score of 30, which exceeds a threshold of 20, whereby the offer engine 124 recognizes a link between the consumer 114 and the consumer 116. As another example, based on the diagram 500 of FIG. 5, the consumer 114 and consumer 116 each spent more than nine hours in Region A in the illustrated day in FIG. 5, and therefore, the mapped time spent exceeds a nine hour threshold, whereby the offer engine 124 recognizes a link between the consumer 114 and the consumer 116.

It should be appreciated that a variety of other thresholds may be employed to identify linked consumers (and communication devices). For instance, predetermined thresholds may be selected to exclude coworkers, etc. What's more, time spent in certain regions, or together at certain times of a day, or together at certain days of the week, etc. as well as data relating to the particular locations (e.g., residential locations versus commercial locations, etc.) may be more indicative of linked consumers and the particular links between the consumers (e.g., time spent in the same residential region at night may suggest family links while time spent in the same commercial region during the day may suggest coworker links, etc.). For example, in generating the probability score (at 310), the devices commonly located with the communication device 118 at times 0-8 and 18-23 may be flagged or tagged as “2” (since these times may suggest family members being at the same location). Similarly, in mapping time spent by the consumers 114 and 116 in common regions (at 314), the offer engine 124 may understand overlaps in Region A (e.g., when Region A is a home address or location of the consumer 114, etc.) to be more relevant than overlaps in other regions. In another example, the predetermined threshold may be time of day specific. For instance, when the time spent by different consumers overlap during the night, it may be assumed that the consumers share the same residence, and thus should be linked. Thereafter, the offer engine 124 may recognize the consumers as linked. In yet another example, as shown in FIG. 5, for instance, when consumers are present in a sequence of regions, such as Regions B, C, D, E, and F, the offer engine 124 may recognize a link between the consumers because the sequence of regions is consistent based on duration and/or time of day (i.e., each is within 4 hours in FIG. 4), and is more than a 30-minute predetermined threshold.

Separately in the method 300, the offer engine 124 accesses transaction data for the consumers 114 and 116 and, potentially, other consumers, at 318. The transaction data may be accessed from the data structure 126, as indicated by the dotted line in FIG. 3, when the transaction data is received by the offer engine 124 and stored in the data structure 126. It should be appreciated, however, that the transaction data may be accessed elsewhere or at other times in other embodiments.

Once accessed, the offer engine 124 aggregates, at 320, device identifiers (or device IDs) for the communication devices 118 and 120 based on a common identifier associated with the mobile application 122. As described above, this allows for multiple different devices (in addition to the communication devices 118 and 120) associated with and/or used by the consumers 114 and 116, respectively, to be accounted for and linked to each of the consumers 114 and 116 (e.g., to provide a full picture of all potential devices associated with the respective consumers 114 and 116, etc.). Such aggregating (or accounting), in turn, helps ensure that a complete/full spend profile for each of the consumers 114 and 116 is taken into account and/or addressed in the method 300, regardless of how may devices each may be associated with (e.g., prior to subsequently bundling or clustering the consumers 114 and 116 into groups/categories, etc.).

Thereafter, the offer engine 124 processes the transaction data, for each of the consumers 114 and 116, and identifies (or clusters), at 322, the consumers 114 and 116 to one or more groups based on the purchase behaviors of the consumers 114 and 116. Examples of such groups may include, without limitation, luxury shoppers (e.g., consumers with higher spending or spending above predefined thresholds in MCCs related to luxury items such jewelry, giftware, apparel, etc.; etc.); food enthusiasts (e.g., consumers with consistent spending at hotels, bars, restaurants, etc.: etc.), travelers (e.g., consumers that frequently spend at airlines, hotels, out of country merchants, etc.; etc.), pet owners (e.g., consumers with spending at veterinarians, pet stores, etc.; etc.), etc.

With the consumers 114 and 116 identified to specific groups, the offer engine 124 then bundles, at 324, the groups for linked ones of the consumers 114 and 116 and/or communication devices 118 and 120. Here, because the communication devices 118 and 120, and by extension, the consumers 114 and 116, are linked, the offer engine 124 bundles each of the groups to which the consumers 114 and 116 are identified. For example, when the consumer 114 is identified to a food enthusiasts group and the consumer 116 is identified to a pet owners group, the offer engine 124 bundles the two groups (such that the bundled groups include the food enthusiasts group and the pet owners group).

In turn, the offer engine 124 identifies offers specific to each of the groups in the bundle, at 326 (e.g., offers specific to the food enthusiasts group and the pet owners group in the above example, etc.). The offers may be identified from the data structure 126 (as indicated by the dotted line in FIG. 3) or from one or more other data structures. For example, merchants associated with and/or providing the offers may be preregistered with the offer engine 124 to facilitate such offers. In connection therewith, when the consumers 114 and 116 belong to the same preassigned group or cluster, and only consumer 114 is a customer of the merchant 102, through the platform of the present disclosure, the merchant 102 may acquire consumer 116 as a customer via the bundling and associated offer. Or, when the consumers 114 and 116 spend with two different merchants, the present disclosure may operate as a backend platform for a type of collaboration between the merchants, where the merchants may give bundled offers to either or both consumers. With that said, the offers may include coupons, discounts, rebates, etc., which are stored in the data structure 126 or are provided/stored elsewhere (e.g., at a coupon provider, etc.).

Finally in the method 300, once identified, the offers are provided, by the offer engine 124, to one or both of the consumers 114 and 116, at 328. The consumers 114 and 116 may then accept the offers (e.g., a coupon, a rebate, a discount, etc.) by redeeming the offers at one or more merchants, or otherwise.

The systems and methods herein thus identify consumers for offers in a new and unconventional manner. Instead of directing offers to consumers based on their particular transaction data, the systems and methods herein direct offers to consumers based on transaction data for other consumers. In so doing, the systems and methods herein identify links between the consumers and the other consumers, independent of their transaction data, and then focus the offers based on such links. In this manner, a first consumer may receive an offer for/based on a second consumer with whom he/she is linked, thereby permitting the first consumer to take advantage of the offer on behalf of the second consumer, or at least to subsequently provide the offer to the second consumer (or, potentially, even use the offer himself/herself). In this manner, the systems and methods herein provide a manner of reaching/targeting consumers for offers not previously available or reachable for such offers or for whom such offers wound not normally be presented (if such offers were based only on the consumers' transaction data).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving location records for a first user from a communication device associated with the first user; (b) receiving location records for a second user from a communication device associated with the second user, the location records for the first and second users each including at least location data and a time stamp of the location data; (c) determining, by an offer engine computing device, an overlap between the first user and the second user in at least one region based on at least the time stamp included in the location records; (d) recognizing, by the offer engine computing device, a link between the first user and the second user, when the overlap satisfies a predetermined threshold; (e) identifying an offer based on transaction data of the first user; and (f) providing the identified offer to the second user based on the recognized link between the first user and the second user.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9, and so forth.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in directing offers to users based on data specific to other users, when the users and the other users are linked, the method comprising:
receiving location records for a first user from a communication device associated with the first user;
receiving location records for a second user from a communication device associated with the second user, the location records for the first and second users each including at least location data and a time stamp of the location data;
determining, by an offer engine computing device, an overlap between the first user and the second user in at least one region based on at least the time stamp included in the location records;
recognizing, by the offer engine computing device, a link between the first user and the second user, when the overlap satisfies a predetermined threshold;
identifying an offer based on transaction data of the first user; and
providing the identified offer to the second user based on the recognized link between the first user and the second user.

2. The computer-implemented method of claim 1, wherein determining the overlap between the first user and the second user includes:
identifying the at least one region relative to the communication device associated with the first user; and
determining the overlap based on at least one interval during which the communication device associated with the second user is disposed within the at least one region.

3. The computer-implemented method of claim 2, wherein determining the overlap between the first user and the second user further includes generating a score for the second user and/or for the communication device associated with the second user based on at least an assigned value for the at least one interval during which the communication device associated with the second user is disposed within the at least one region; and
wherein recognizing the link between the first user and the second user includes recognizing the link when the score satisfies the predefined threshold.

4. The computer-implemented method of claim 3, wherein the score includes a combination of an aggregate score and a likelihood score, the aggregate score based on the assigned value for the at least one interval during which the communication device associated with the second user is disposed within the at least one region and the likelihood score based on historical location records for at least one of the first and second users.

5. The computer-implemented method of claim 1, further comprising:
aggregating, for each of the first and second users, by the offer engine computing device, time spent within the at least one region based on the location records for the user; and
mapping, by the offer engine computing device, the time spent within the at least one region by the first user with and the time spent within the at least one region by the second user for multiple intervals of time;
wherein determining the overlap between the first user and the second user includes identifying one or more of the intervals in which the mapped time spent by the first and second users within the at least one region coincide.

6. The computer-implemented method of claim 5, further comprising:
for each of the first and second users, aggregating time spent at a third region based on the location records for the user;
mapping, by the offer engine computing device, the time spent at the third region for the first user and the time spent at the third region by the second user; and
recognizing, by the offer engine computing device, a link between the first user and the second user, when the mapped times spent at the first region, the second region and the third region are consistent based on duration and time of day and satisfy the predetermined threshold.

7. The computer-implemented method of claim 1, further comprising:
assigning the first user to a first group based on transaction behavior indicated by the transaction data of the first user; and
wherein identifying the offer based on the transaction data includes identifying the offer based on the group.

8. The computer-implemented method of claim 7, further comprising:
assigning the second user to a second group based on transaction behavior indicated by transaction data of the second user; and
bundling the first and second group; and then
identifying the offer and at least one other offer based on the bundled first and second groups;
wherein providing the identified offer includes providing the identified offer and the at least one other offer to the second user based on the recognized link between the first user and the second user.

9. The computer-implemented method of claim 1, further comprising identifying the at least one region relative to the communication device associated with the first user; and
wherein the at least one region includes at least a first region and a second region different from the first region.

10. The computer-implemented method of claim 9, wherein determining the overlap between the first user and the second user includes generating a score for the second user and/or for the communication device associated with the second user based on at least one interval during which the communication device associated with the second user is disposed within the first region and at least one interval during which the communication device associated with the second user is disposed within the second region.

11. A system for use in directing offers to users based on data specific to other users, when the users and the other users are linked, the system comprising:
a memory including location records received from a first communication device and a second communication device, the first communication device associated with a first user and the second communication device associated with a second user, and each of the location records including at least location data and a time stamp of the location data; and a processor coupled to the memory, the processor configured to:
determine a region associated with the first communication device based on location data received from the first communication device and a predefined radius;
determine an overlap between the region and location data received from the second communication device;
recognize a link between the first user and the second user, when the overlap satisfies a predetermined threshold;
identify an offer based on transaction data of the first user; and
provide the identified offer to the second user based on the recognized link between the first user and the second user.

12. The system of claim 11, wherein the processor is configured, in connection with determining the overlap between the region and the location data received from the second communication device, to generate a score indicative of time spent by the second communication device within the region; and
wherein the processor is configured, in connection with recognizing the link between the first user and the second user, to recognize the link between the first user and the second user when the score satisfies the at least one threshold.

13. The system of claim 11, wherein the first communication device is at a first location at a first time interval and at a second location at a second time interval, and wherein the overlap includes the first and second time intervals; and
wherein the processor is configured, in connection with recognizing the link between the first user and the second user, to recognize the link based on an assigned value for the first time interval at the first location and the second time interval at the second location, when the assigned value satisfies the predetermined threshold.

14. The system of claim 11, wherein the processor is further configured, in connection with determining the overlap between the region and location data received from the second communication device, to determine the overlap based on at least one interval during which the second communication device is disposed within the region.

15. The system of claim 14, wherein the processor is further configured, in connection with determining the overlap between the region and location data received from the second communication device, to generate a score for the second user and/or the second communication device based on at least an assigned value for the at least one interval during which the second communication device is disposed within the region; and
wherein the processor is further configured, in connection with recognizing the link between the first user and the second user, to recognize the link when the score satisfies the predefined threshold.

16. The system of claim 15, wherein the score includes a combination of an aggregate score and a likelihood score, the aggregate score based on the assigned value for the at least one interval during which the second communication device is disposed within the region and the likelihood score based on historical location records for at least one of the first and second users.

17. A non-transitory computer-readable storage media including executable instructions for use in directing offers to users based on data specific to other users, when the users and the other users are linked, which, when executed by at least one processor, cause the at least one processor to:
receive location records for a first user from a communication device associated with the first user;
receive location records for a second user from a communication device associated with the second user, the location records for the first and second users each including at least location data and a time stamp of the location data;
identifying at least one region relative to the communication device associated with the first user and determine an overlap between the first user and the second user in the at least one region based on at least one interval during which the communication device associated with the second user is disposed within the at least one region;
recognize a link between the first user and the second user, when the overlap satisfies a predetermined threshold;
identify an offer based on transaction data of the first user; and
provide the identified offer to the second user based on the recognized link between the first user and the second user.

18. The non-transitory computer-readable storage media of claim 17, wherein the executable instructions, when executed by the at least one processor, further cause the at least one processor, in connection with determining the overlap between the first user and the second user, to generate a score for the second user and/or for the communication device associated with the second user based on at least an assigned value for the at least one interval during which the communication device associated with the second user is disposed within the at least one region; and
wherein the executable instructions, when executed by the at least one processor, further cause the at least one processor, in connection with recognizing the link between the first user and the second user, to recognize the link when the score satisfies the predefined threshold.

19. The non-transitory computer-readable storage media of claim 17, wherein the executable instructions, when executed by the at least one processor, further cause the at least one processor to assign the first user to a first group based on transaction behavior indicated by the transaction data of the first user; and
wherein the executable instructions, when executed by the at least one processor, further cause the at least one processor, in connection with identifying the offer based on the transaction data, to identify the offer based on the group.
